(19) United States
(12) Patent Application Publication
(10) Pub. No.: US 2018/0276052 A1
(43) Pub. Date: Sep. 27, 2018

(54) DEADLOCK DETECTOR, SYSTEM INCLUDING THE SAME AND ASSOCIATED METHOD

(71) Applicant: Samsung Electronics Co., Ltd., Suwon-si (KR)

(72) Inventors: Jae-Youl KIM, Yongin-si (KR); Yun-Gwan YU, Suwon-si (KR)

(21) Appl. No.: 15/670,370

(22) Filed: Aug. 7, 2017

(30) Foreign Application Priority Data
Mar. 22, 2017 (KR) 10-2017-0036260

(51) Int. Cl. G06F 9/52; G06F 11/30; G06F 11/36

(52) U.S. Cl. CPC G06F 9/524; G06F 13/36; G06F 11/362; G06F 11/3089

(57) ABSTRACT

A system includes a plurality of hardware blocks, a deadlock detector and an interconnect device. The hardware blocks include a processor executing instructions and a storage device storing data. The deadlock detector monitors operations of a target hardware block among the plurality of hardware blocks in realtime to store debugging information in the storage device. The interconnect device electrically connects the deadlock detector and the plurality of hardware blocks. The interconnect device includes a system bus electrically connecting the plurality of hardware blocks and a debugging bus electrically connecting the deadlock detector to the target hardware block and the storage device. The interconnect device includes a system bus electrically connecting the plurality of hardware blocks and a debugging bus electrically connecting the deadlock detector to the target hardware block and the storage device.

### CROSS-REFERENCE TO RELATED APPLICATION

This U.S. Non-provisional application claims priority under 35 USC § 119 to Korean Patent Application No. 10-2017-0036260, filed on Mar. 22, 2017, in the Korean Intellectual Property Office (KIPO), the disclosure of which is incorporated by reference in its entirety herein.

### BACKGROUND

### 1. Technical Field

Example embodiments relate generally to semiconductor integrated circuits, and more particularly to a deadlock detector, a system including a deadlock detector and a method of detecting deadlock in a system.

### 2. Discussion of the Related Art

When a hardware block such as a central processing unit (CPU) core of a system falls in deadlock, debugging may be required to seek and resolve a cause of the deadlock. If a system has fallen in deadlock, it may be difficult to monitor the system by connecting an external debugger to the system. Conventionally, deadlock in a system may be determined using a watchdog timer to extract data for debugging. The expired time of the watchdog is about ten seconds. Thus, a root cause of deadlock may disappear during debugging processes before collecting the debugging information. As such, it may be difficult to find and analyze a time point and a cause of the deadlock.

### SUMMARY

Some example embodiments may provide a deadlock detector capable of detecting deadlock in a system in realtime to secure debugging information.

Some example embodiments may provide a system including a deadlock detector capable of detecting deadlock in the system in realtime to secure debugging information.

Some example embodiments may provide a method of detecting deadlock detector capable of detecting deadlock in a system in realtime to secure debugging information.

According to example embodiments, a system includes: a plurality of hardware blocks, at least one hardware block among the plurality of hardware blocks including a processor configured to execute instructions and at least one hardware block among the plurality of hardware blocks including a storage device configured to store data; a deadlock detector configured to monitor operations of a target hardware block among the plurality of hardware blocks in realtime to generate a monitoring signal indicating an abnormal state of the target hardware block and to store debugging information in the storage device in response to generation of the monitoring signal; and an interconnect device electrically connecting the deadlock detector and the plurality of hardware blocks, the interconnect device comprising, a system bus electrically connecting the plurality of hardware blocks; and a debugging bus electrically connecting the deadlock detector to the target hardware block and the storage device.

According to example embodiments, a system includes: a plurality of hardware blocks; and a deadlock detector for collecting debugging information of the system. The deadlock detector comprises: a monitoring unit configured to monitor operations of a target hardware block among the plurality of hardware blocks in realtime to generate a monitoring signal indicating an abnormal state of the target hardware block; a debugging core configured to store the debugging information in a storage device corresponding to one of the plurality of the hardware blocks based on the monitoring signal; and a debugging bus configured to electrically connect the deadlock detector to the target hardware block and the storage device

According to example embodiments, a method of detecting deadlock in a system including a plurality of hardware blocks is provided. The method includes electrically connecting a deadlock detector to a target hardware block among the plurality of hardware blocks that includes a processor configured to execute instructions and to at least one hardware block among the plurality of hardware blocks that includes a storage device configured to store data, monitoring operations of the target hardware block in realtime to generate a monitoring signal indicating an abnormal state of the target hardware block, using the deadlock detector and storing debugging information in the storage device based on the monitoring signal, using the deadlock detector.

According to example embodiments, a method of diagnosing a system includes electrically connecting a deadlock detector to a storage device and a target hardware block, monitoring operations of the target hardware block in realtime to generate a monitoring signal indicating an abnormal state of the target hardware block, storing debugging information in the storage device based on the monitoring signal, resetting the system after the debugging information is stored, providing the debugging information to an external device after the system is reset and performing a debugging operation based on the debugging information.

According to example embodiments, a multi-core system includes: a plurality of hardware blocks, at least one hardware block among the plurality of hardware blocks including a processor configured to execute instructions and at least one hardware block among the plurality of hardware blocks including a storage device configured to store data; a deadlock detector configured to monitor operations of the at least one hardware block among the plurality of hardware blocks that includes the processor in realtime to store debugging information in the storage device; and an interconnect device electrically connecting the deadlock detector and the plurality of hardware blocks.

According to example embodiments, a system includes: a plurality of processor circuits; a deadlock detector configured to monitor operations of at least one target processor circuit among the plurality of processor circuits in realtime to store debugging information in an external storage device; and an interconnect device electrically connecting the deadlock detector and the plurality of processor circuits.

The deadlock detector, the system including the deadlock detector and the associated method according to example embodiments may support efficient debugging and enhance probability of success in debugging by monitoring the abnormal state of the system in realtime to secure the debugging information.

### BRIEF DESCRIPTION OF THE DRAWINGS

Example embodiments of the present disclosure will be more clearly understood from the following detailed description taken in conjunction with the accompanying drawings.

FIG. 1 is a flow chart illustrating a method of detecting deadlock in a system according to example embodiments.

FIG. 2 is a block diagram illustrating a system according to example embodiments.

FIG. 3 is a block diagram illustrating a bus structure of the system of FIG. 2.

FIG. 4 is a block diagram illustrating an example embodiment of a target hardware block and a monitoring unit.

FIG. 5 is a block diagram illustrating an example embodiment of a performance monitor unit included in the target hardware block in FIG. 4.

FIG. 6 is a diagram illustrating example events of the target hardware block in FIG. 4.

FIG. 7 is a diagram for describing operations of the monitoring unit in FIG. 4.

FIG. 8 is a block diagram illustrating an example embodiment of a target hardware block and a monitoring unit.

FIG. 9 is a diagram for describing operations of the monitoring unit in FIG. 8.

FIG. 10 is a block diagram illustrating a deadlock detector according to example embodiments.

FIG. 11 is a diagram for describing an example embodiment of storing debugging information.

FIG. 12 is a diagram for describing power domains of a system according to example embodiments.

FIG. 13 is a diagram illustrating an accumulator model for realtime monitoring according to example embodiments.

FIG. 14 is a block diagram illustrating an example embodiment of a monitoring unit using the accumulator model of FIG. 13.

FIG. 15 is a block diagram illustrating an example embodiment of a latency detector included in the monitoring unit of FIG. 14.

FIG. 16 is a timing diagram illustrating an example transaction performed by a system and a current latency detected by the latency detector of FIG. 15.

FIG. 17 is a block diagram illustrating a system according to example embodiments.

FIG. 18 is a block diagram illustrating a clock monitor included in the system of FIG. 17.

FIG. 19 is a block diagram illustrating a system according to example embodiments.

FIG. 20 is a block diagram illustrating a diagnosis system according to example embodiments.

FIG. 21 is a flow chart illustrating a method of diagnosing a system according to example embodiments.

### DETAILED DESCRIPTION OF THE EMBODIMENTS

Various example embodiments will be described more fully hereinafter with reference to the accompanying drawings, in which some example embodiments are shown. In the drawings, like numerals refer to like elements throughout. The repeated descriptions may be omitted.

As used herein, and unless indicated otherwise, items described as being “electrically connected” are configured such that an electrical signal can be passed from one item to the other.

As is traditional in the field of the inventive concepts, embodiments are described, and illustrated in the drawings, in terms of functional blocks, units and/or modules. Those skilled in the art will appreciate that these blocks, units and/or modules are physically implemented by electronic (or optical) circuits such as logic circuits, discrete components, microprocessors, hard-wired circuits, memory elements, wiring connections, and the like, which may be formed using semiconductor-based fabrication techniques or other manufacturing technologies. In the case of the blocks, units and/or modules being implemented by microprocessors or similar, they may be programmed using software (e.g., microcode) to perform various functions discussed herein and may optionally be driven by firmware and/or software. Alternatively, each block, unit and/or module may be implemented by dedicated hardware, or as a combination of dedicated hardware to perform some functions and a processor (e.g., one or more programmed microprocessors and associated circuitry) to perform other functions. Also, each block, unit and/or module of the embodiments may be physically separated into two or more interacting and discrete blocks, units and/or modules without departing from the scope of the inventive concepts. Further, the blocks, units and/or modules of the embodiments may be physically combined into more complex blocks, units and/or modules without departing from the scope of the inventive concepts.

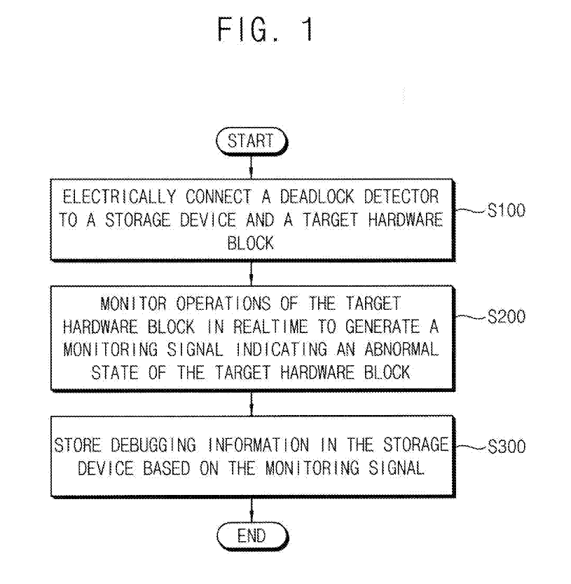

FIG. 1 is a flow chart illustrating a method of detecting deadlock in a system according to example embodiments. FIG. 1 illustrates a method of detecting deadlock for collecting debugging information of a system including a plurality of hardware blocks (e.g., processor circuits).

Referring to FIG. 1, a deadlock detector may be electrically connected to a storage device and a target hardware block among the plurality of hardware blocks (S100).

Operations of the target hardware block may be monitored in realtime to generate a monitoring signal indicating an abnormal state of the target hardware block, using the deadlock detector (S200). Debugging information may be stored in the storage device based on the monitoring signal, using the deadlock detector (S300).

The target hardware block may be set to be one or more hardware blocks such that the operation of the target hardware block may cause, with relatively high probability, the system to fall in an abnormal state such as deadlock. The abnormal state may represent all phenomena that the operation of the system is suspended temporarily or permanently during a booting process of the system or after the booting process is completed because of problems in software and/or hardware. For example, the abnormal state of the system may include kernel panic, lockup, hang, freeze, etc. which may be referred to as deadlock as a whole. For example, kernel panic may refer to an action taken by an operating system (OS) upon detecting an internal fatal error from which the OS may not safely recover, and lockup or hang or freeze occurs when either a computer program or OS ceases to respond to inputs.

The deadlock detection method according to example embodiments may monitor hardware behavior in realtime, for example, while an OS works. For example, the hardware behavior may be monitored periodically in synchronization with a timer interrupt and the debugging information may be collected if abnormality is detected. In case of the OS, performance monitoring with a short cyclic period may be difficult by conventional methods, but the deadlock detector according to example embodiments may collect the debugging information with a cyclic period shorter than one millisecond.

If a system on chip (SOC) falls in an abnormal state during a normal operation, it takes relatively a long time to analyze a cause thereof. A conventional scheme depending on software may not catch all status of logics in the SOC at a time point when the SOC falls in deadlock. In contrast, the deadlock detector and the method of deadlock detection according to example embodiments may extract and store information of hardware logic in order to find an exact cause of the problem in the hardware logic.

In some conventional methods, software log may be used for post-analysis. Using these methods, however, an exact cause of deadlock may not be analyzed exactly in case of hardware problems. In contrast, the deadlock detector and the method of deadlock detection according to example embodiments may solve hardware problems in addition to software problem.

In other conventional methods, break point may be inserted in software codes and an external tester may extract and analyze the associated information if an event associated with the break point occurs. In contrast, the deadlock detector and the method of deadlock detection according to example embodiments may secure the debugging information at a time of deadlock regardless of the predetermined break point.

As such, the deadlock detector, the system including the deadlock detector and the associated method according to example embodiments may support efficient debugging and enhance probability of success in debugging by monitoring the abnormal state of the system in realtime to secure the debugging information.

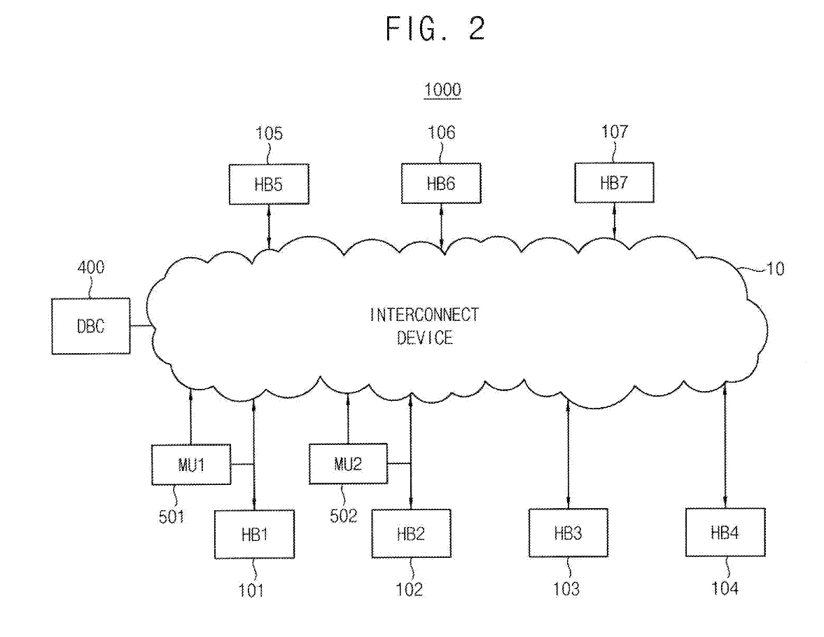

FIG. 2 is a block diagram illustrating a system according to example embodiments. The system may be a system on chip (SOC) in which various semiconductor components are integrated as one chip.

Referring to FIG. 2, a system 1000 includes a plurality of hardware blocks HB1˜HB7 101˜107, one or more monitoring units MU1 and MU2 501 and 502, a debugging core DBC 400 and an interconnect device 10. Some hardware blocks may be master devices and other hardware blocks may be slave devices. The master devices may generate requests to demand services from at least one of the slave devices, respectively. For example, the master device may include a processor configured to execute instructions and the slave device may include a storage device configured to store data.

At least one of the hardware blocks 101˜107 may be determined as a target hardware block that is an object of monitoring. For example, as illustrated in FIG. 2, a first hardware block 101 and a second hardware block 102 may be set to be target hardware blocks and monitoring units 501 and 502 may be assigned to the target hardware blocks 101 and 102, respectively. Each monitoring unit may monitor the operations of the corresponding target hardware block in realtime to generate a monitoring signal indicating an abnormal state of the corresponding target hardware block, as will be described below.

The debugging core 400 may store the debugging information in a storage device based on the monitoring signal. The storage device may correspond to one of the hardware blocks 101˜107. The interconnect device 10 may electrically connect the deadlock detector and the plurality of hardware blocks.

The number of the hardware blocks and the number of the monitoring units may be determined variously. According to operational characteristics of the target hardware blocks, the monitoring units may have different configurations.

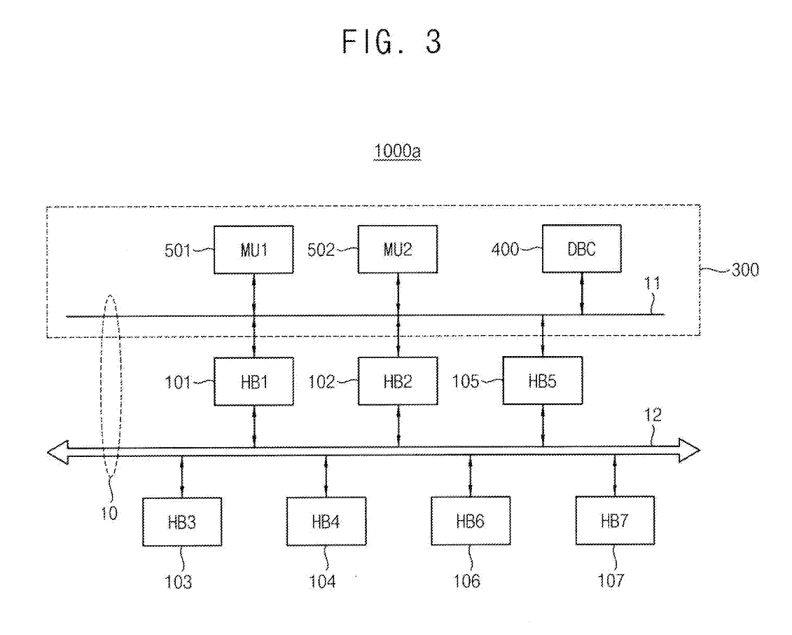

FIG. 3 is a block diagram illustrating a bus structure of the system of FIG. 2.

Referring to FIGS. 2 and 3, an interconnect device 10 of a system 1000a may include a debugging bus 11 and a system bus 12. The system bus 12 may electrically connect the plurality of hardware blocks 101˜107. The debugging bus 11 may electrically connect a deadlock detector 300 to the target hardware blocks 101 and 102 and a storage device. For example, the two hardware blocks 101 and 102 may be the target hardware blocks and the one hardware block 105 may be the storage device as illustrated in FIG. 3. In some example embodiments, the two hardware blocks 101 and 102 and the storage device (hardware block 105) may be directly electrically connected to the debugging bus 11 and the system bus 12. In some example embodiments, the hardware blocks 103, 104, 106, and 107 may be directly electrically connected to the system bus 12, but may not be directly electrically connected to the debugging bus 11. Directly electrically connected elements may be directly physically connected and directly electrically connected.

The deadlock detector 300 may include one or more monitoring units 501 and 502 and the debugging core 400. The monitoring units 501 and 502 may monitor the operations of the target hardware blocks 101 and 102 in realtime to generate the monitoring signal indicating abnormal states of the target hardware blocks 101 and 102, respectively. The debugging core 400 may store the debugging information in the storage device (e.g., hardware block 105) based on the monitoring signal.

In some example embodiments, the debugging bus 11 may be a distinct bus that is physically differentiated from the system bus 12. In other example embodiments, the debugging bus 11 may be a subsidiary bus of a multi-port bus and the debugging bus 11 and the system bus 12 may use different port of the multi-port bus. As such, by differentiating the debugging bus 11 and the system bus 12, the deadlock detector 300 may detect the deadlock in real time to secure the debugging information even though the system bus 12 falls in some hardware problems. In some example embodiments, the debugging information may include trace information of a bus debug unit (BDU). For example, tracing may involve a specialized use of logging to record information about a program's execution so that a programmer may use this information for debugging purposes.

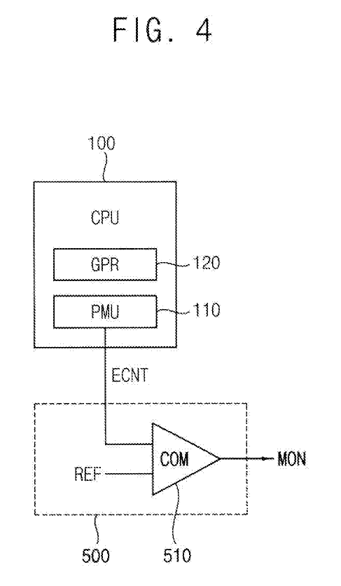

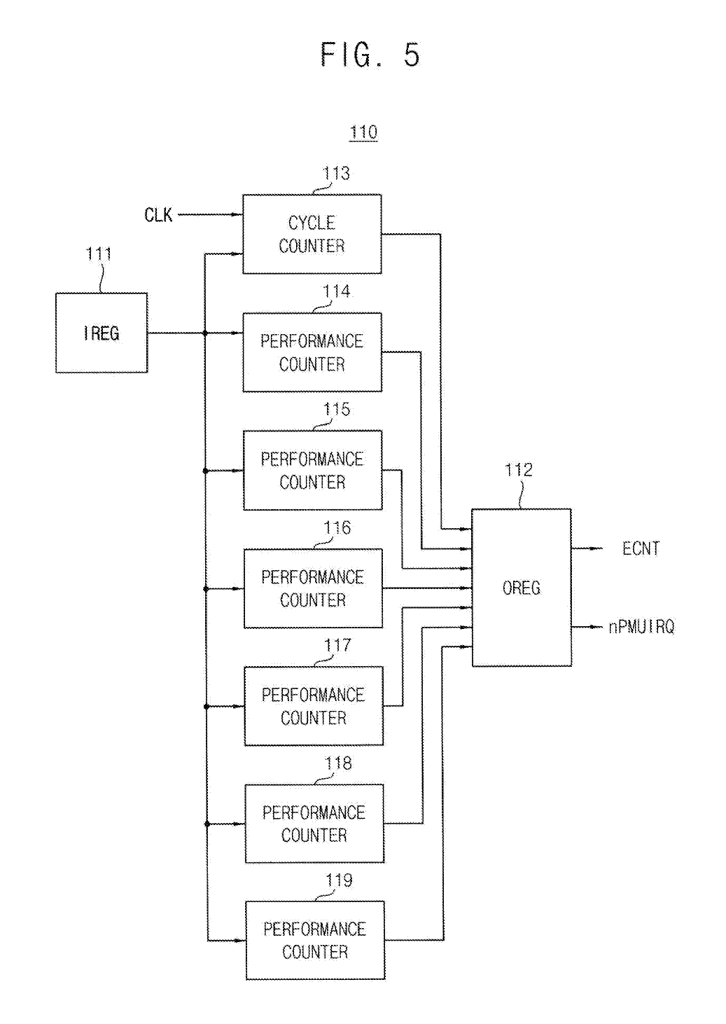

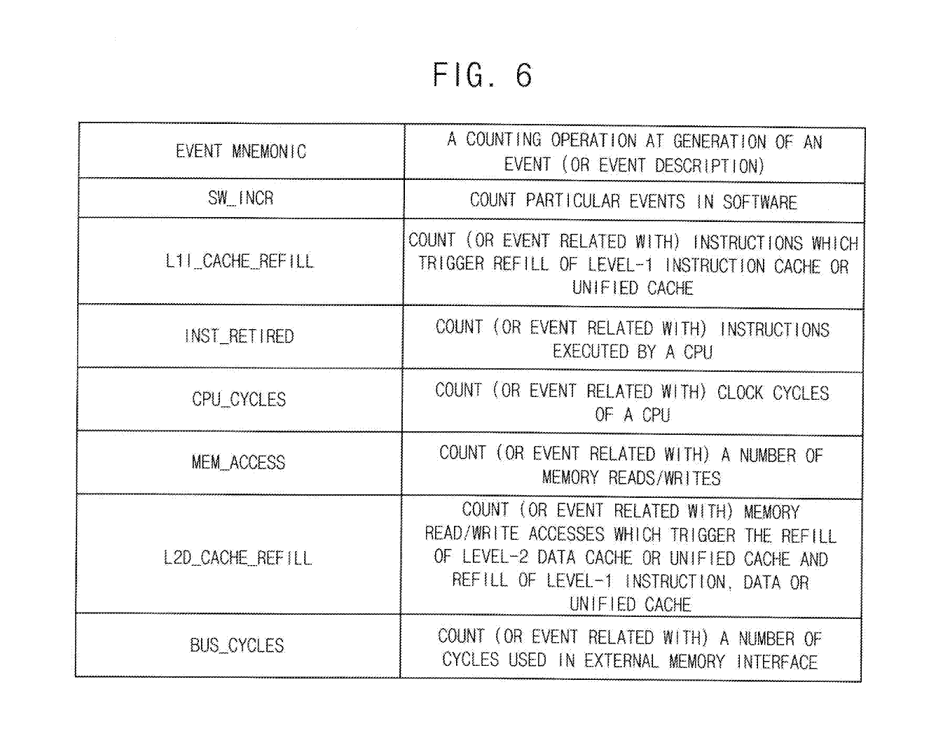

FIG. 4 is a block diagram illustrating an example embodiment of a target hardware block and a monitoring unit, FIG. 5 is a block diagram illustrating an example embodiment of a performance monitor unit included in the target hardware block in FIG. 4, and FIG. 6 is a diagram illustrating example events of the target hardware block in FIG. 4.

Referring to FIG. 4, a target hardware block may correspond to a processor 100 such as a central processing unit (CPU). The processor 100 may include a performance monitor unit (PMU) 110 and a general purpose register (GPR) 120. The monitoring unit 500 may include a comparator COM 510.

The GPR 120 is a register used for various purposes such as temporary storage, arithmetic and logical operations, address indexing, and so on. The GPR 120 may be distinguished from special function registers such as a program counter, an instruction counter, and so on.

As illustrated in FIG. 5, the PMU 110 may include an input register IREG 111, an output register OREG 112, a cycle counter 113 and a plurality of performance counters 114˜119. The input register 111 may receive events of the processor 100 and/or external events to control counting operations of the counters 113˜119 based on the received events. For example, the events may be represented by respective internal signals. The cycle counter 113 operates based on a clock signal CLK and the output of the input register 111. The cycle counter 113 may determine the length of a cycle (or cyclic period) by counting a number of the clock signals CLK (e.g., which may be a periodic internal clock) to a predetermined number, such that when the predetermined number is reached, the end of the current cycle is determined by the count of the cycle counter 113. Upon the end of the current cycle (upon counting to the predetermined number), cycle counter 113 may output a corresponding signal to output register OREG 112 to cause OREG 112 to latch the current count values of performance counters 114˜119 and to cause OREG 112 generate an interrupt signal nPMUIRQ and an event count signal ECNT based on values stored in the counters 113˜119. The interrupt signal nPMUIRQ may be activated when the PMU 110 issues interrupt and the interrupt signal nPMUIRQ may be provided to an external device. The event count signal ECNT may include multiple bits and comprise the latched count values of performance counters 114˜119 and represent counts of the monitored events of the previous cyclic period.

FIG. 6 illustrates some PMU events that are used in ARM® Cortex®-A series processors. The event mnemonics such as SW_INCR, L1I_CACHE_REFILL, INST_RETIRED, CPU_CYCLES, MEM_ACCESS, L2D_CACHE_REFILL, BUS_CYCLES are shown in a left column in FIG. 6 and the corresponding counting operations or event descriptions are shown in a right column in FIG. 6. For example, the event mnemonic SW_INCR corresponds to software increment, e.g., corresponds to a counting operation that counts particular events in software. The event mnemonic L1I_CACHE_REFILL corresponds to a counting operation that counts (or event related with) instructions which trigger refill of level-1 instruction cache or unified cache. The event mnemonic INST_RETIRED corresponds to a counting operation that counts (or event related with) instructions executed by a CPU. The event mnemonic CPU_CYCLES corresponds to a counting operation that counts (or event related with) clock cycles of a CPU. The event mnemonic MEM_ACCESS corresponds to a counting operation that counts (or event related with) a number of memory reads/writes. The event mnemonic L2D_CACHE REFILL corresponds to a counting operation that counts (or event related with) memory read/write accesses which trigger the refill of level-2 data cache or unified cache and refill of level-1 instruction, data or unified cache. The event mnemonic corresponds to a counting operation that counts (or event related with) a number of cycles used in external memory interface.

The monitoring unit 500 may, using count values of such events, monitor the operations of the target hardware block in realtime to generate a monitoring signal MON indicating an abnormal state of the target hardware block.

In some example embodiments, as illustrated in FIG. 4, the monitoring unit 500 may receive an event count value ECNT corresponding to a counted number of the monitored events and compare the event count value ECNT with a reference value REF to generate the monitoring signal MON. In some examples, an event count value ECNT may be generated for each event to be monitored and compared to a corresponding reference value REF, such as with a corresponding comparator 510, and the monitoring signal MON may be generated in response to the comparison, such as when any event count value ECNT falls below (or alternatively, exceeds) its corresponding reference value REF.

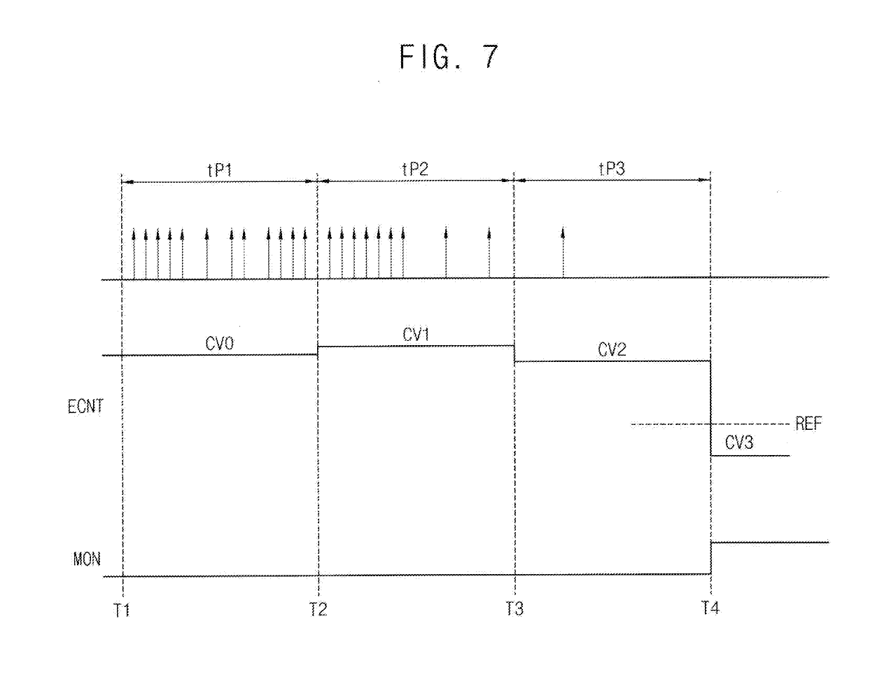

FIG. 7 is a diagram for describing operations of the monitoring unit in FIG. 4.

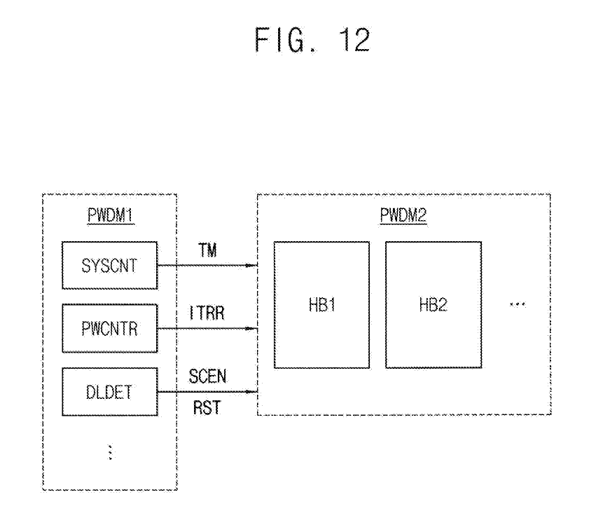

Referring to FIGS. 4 through 7, the PMU 110 of the processor 100 may provide the event count value ECNT periodically. In some example embodiments, the system may include a system counter SYSCNT as illustrated in FIG. 12, and the PMU 110 may provide the event count value ECNT periodically based on time information TM from the system counter SYSCNT so that the monitoring unit 500 of the deadlock detector 300 may monitor the operations of the processor 100 periodically. The events to be monitored, for example the instruction-retired events INST_RETIRED, are represented as arrows. First, second and third count values CV1, CV2 and CV3 corresponding to first, second and third cyclic periods tP1, tP2 and tP3 are illustrated in FIG. 7. The first, second and third periods tP1, tP2 and tP3 correspond to time intervals between adjacent time points T1˜T4 and these time intervals may be equal to each other. The count value CV0 corresponds to the event count value ECNT at time point T1 corresponding to the total of the counted events during the cyclic period immediately before the time point T1. It will be appreciated that as the count value CVn remains fixed to reflect the total counted events of the time period tPn (or nth cyclic period, from time points Tn to Tn+1), a new count value CVn+1 will be generated (and incremented upon the occurrence of each monitored event) in response to monitoring and counting events occurring during time period tPn+1 (from time points Tn+1 to Tn+2). For example, at each time point Tn (e.g., one of time points T1˜T4), the count value in each of the performance counters 114-119 and the count value in cycle counter 113 will be latched by OREG 112 and output as the event count value ECNT, representing the respective counts of the counters 113-119 at time point Tn and thus the total event counts of the n−1th cyclic period. At the same time (or immediately following, such as during the next internal clock cycle of the circuit), each of the counters 113-119 is reset so that their count value is reset to zero and each of the counters increments its count value during the nth cyclic period upon detection of the corresponding monitored event.

As illustrated in FIG. 7, the third count value CV3 corresponding to the third cyclic period tP3 may decrease abruptly below the reference value REF. In this case, the comparator 510 of the monitoring unit 500 may activate the monitoring signal MON, for example, to logic high level. The debugging core 400 may, based on the monitoring signal MON, perform the operation of storing the debugging information.

In this example, when the processor 100 in FIG. 4 enters a standby mode, power to the processor 100 is blocked and the PMU 110 is disabled to stop its operation. The deadlock detector 300 may be disabled when the system enters a standby mode such that power to the processor 100 is blocked, and the deadlock detector 300 may be enabled when the system wakes from the standby mode and enters an active mode. In some example embodiments, enabling and disabling of the deadlock detector 300 may be performed together with the processor 100 based on the same power-down event and the same wakeup event.

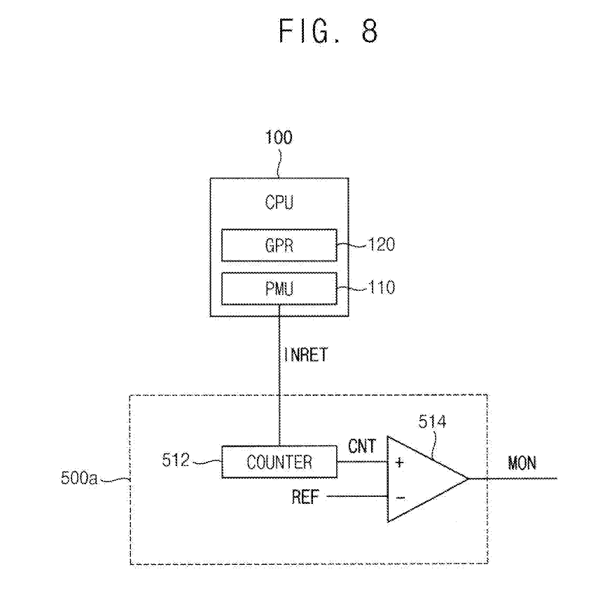

FIG. 8 is a block diagram illustrating an example embodiment of a target hardware block and a monitoring unit.

Referring to FIG. 8, a target hardware block may correspond to a processor 100 such as a central processing unit (CPU). The processor 100 may include a performance monitor unit (PMU) 110 and a general purpose register (GPR) 120 as described with reference to FIG. 4. The exemplary embodiment of FIG. 8 is different from the exemplary embodiment of FIG. 4 in that the monitoring unit 500a of the exemplary embodiment of FIG. 8 may include a counter 512 in addition to a comparator 514.

The PMU 110 may provide an instruction-retired signal INRET. Each instruction is initiated when the instruction is fetched in a pipeline of the processor 100 and the instruction is retired if it is completed through respective stages in the pipeline. The retired instruction indicates “an instruction that is executed and completed normally” and some instructions may not be retired. For example, the processor 100 may drop an instruction while the instruction is executed in the pipeline if the instruction is determined as being unnecessary. Such instruction may be caused by branch prediction, instruction prefetch, etc. which are introduced to enhance the performance of the processor 100.

The instruction-retired signal INRET may be activated by the processor 100 in a pulse form whenever each instruction of the processor 100 is executed and completed, for example, whenever the instruction at the last stage of the pipeline is finally executed and completed. For example, the instruction-retired signal INRET may be activated in a pulse form whenever the instruction-retired event INST_RETIRED in FIG. 5 occurs.

In some example embodiments, as illustrated in FIG. 8, the monitoring unit 500a may receive the instruction-retired signal INRET and generate the monitoring signal MON based on activation timings of the pulses included in the instruction-retired signal INRET.

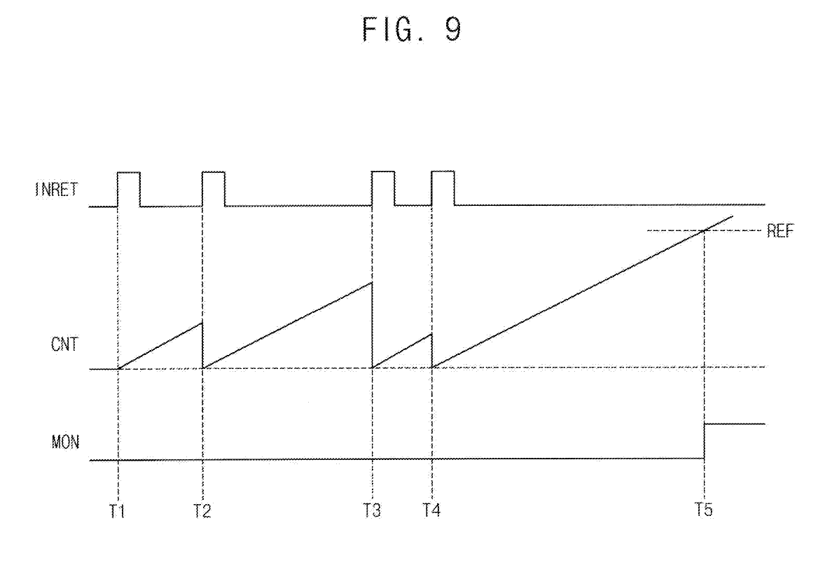

FIG. 9 is a diagram for describing operations of the monitoring unit in FIG. 8.

Referring to FIGS. 8 and 9, the PMU 110 of the processor 100 may provide the instruction-retired signal INRET that is activated in a pulse form whenever the instruction-retired event occurs. For example, as illustrated in FIG. 9, the instruction-retired signal INRET may be activated as pulses at time points T1, T2, T3 and T4.

The counter 512 of the monitoring unit 500a may receive the instruction-retired signal INRET provided from the PMU 110. The counter 512 may generate a count signal CNT by performing a counting operation and the counter 512 may be reset in response to pulses of the instruction-retired signal INRET. As illustrated in FIG. 9, the value of the count signal CNT may increase gradually after it is initialized (or reset) to zero at time points T1, T2, T3 and T4, respectively. In some example embodiments, the counter 512 may be implemented with a ripple counter that counts edges of a regular periodic clock signal and that is reset in response to the instruction-retired signal INRET. The comparator 514 of the monitoring unit 500a may compare the value of the count signal CNT with a reference value

REF to generate the monitoring signal MON.

As illustrated in FIG. 9, the value of the count signal CNT may increase significantly and obtain the reference value REF at time point T5. In one embodiment, the comparator 514 of the monitoring unit 500a may activate the monitoring signal MON, for example, to logic high level when the count value CNT reaches and/or exceeds the reference value REF. For example, the monitoring unit 500a may determine the abnormal state of the processor 100 if the instruction-retired signal INRET is not activated for relatively a long time corresponding to the reference value REF. The debugging core 400 may, in response to the monitoring signal MON transitioning to a logic high level upon the count value CNT reaching the reference value REF, perform the operation of storing the debugging information.

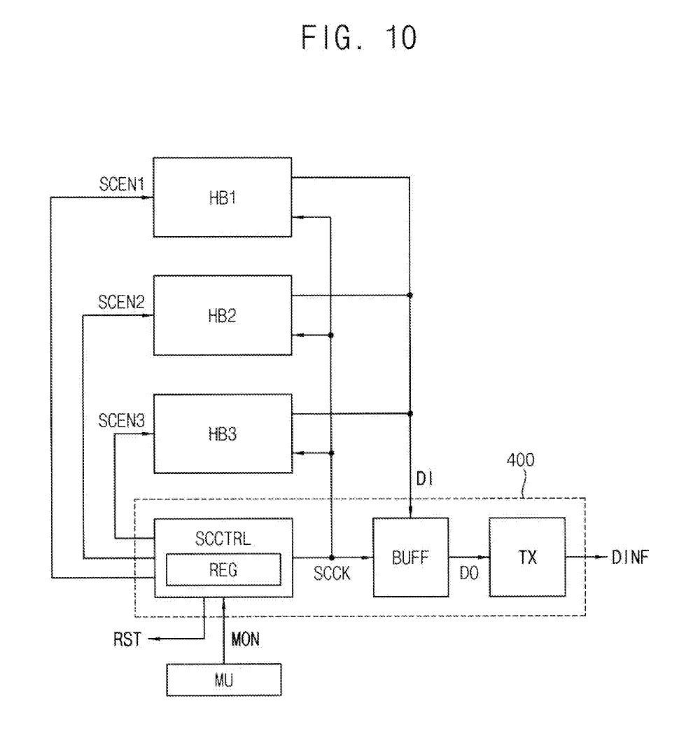

FIG. 10 is a block diagram illustrating a deadlock detector according to example embodiments.

Referring to FIG. 10, a deadlock detector may include at least one monitoring unit

MU and a debugging core 400 as described above. FIG. 10 shows also a plurality of hardware blocks HB1, HB2 and HB3. The debugging core 400 may include a scan controller SCCTRL, a register REG, a buffer BUFF and an output unit TX.

The scan controller SCCTRL may generate scan enable signals SCEN1, SCEN2 and SCEN3 based on the monitoring signal MON from the monitoring unit MU and transfer the scan enable signals SCEN1, SCEN2 and SCEN3 to source hardware blocks HB1, HB2 and HB3 providing the debugging information. The scan enable signals SCEN1, SCEN2 and SCEN3 may indicate a start timing of storing the debugging information and the source hardware blocks HB1, HB2 and HB3 may prepare to provide the debugging information to the debugging core 400 in response to the enable signals SCEN1, SCEN2 and SCEN3. In some example embodiments, the scan controller SCCTRL may be implemented with a microprocessor.

The register REG may store control values for operations of the debugging core 400. For example, the register REG may store information on addresses to which the debugging information is stored, conditions of enable of the debugging core 400, data mask, etc. The register REG may be included in the scan controller SCCTRL as illustrated in FIG. 10 or the register REG may be implemented as being distinct from the scan controller SCCTRL.

The buffer BUFF may receive input data DI corresponding to the debugging information provided from the source hardware blocks HB1, HB2 and HB3 and temporarily store the debugging information. In some example embodiments, the buffer may be implemented with a shift register. The output unit TX may receive output data DO from the buffer BUFF and transfer the debugging information DINF to the storage device.

The scan controller SCCTRL may generate a scan clock signal SCCK and provide the scan clock signal SCCK to the source hardware blocks HB1, HB2 and HB3, the buffer BUFF and the storage device for storing the debugging information DINF. The source hardware blocks HB1, HB2 and HB3, the buffer BUFF and the storage device may perform the backup operation of the debugging information DINF in synchronization with the scan clock signal SCCK. As such, using the scan clock signal SCCK from the scan controller SCCTRL, the debugging information DINF may be secured safely even though an operation clock signal of the source hardware block has a problem.

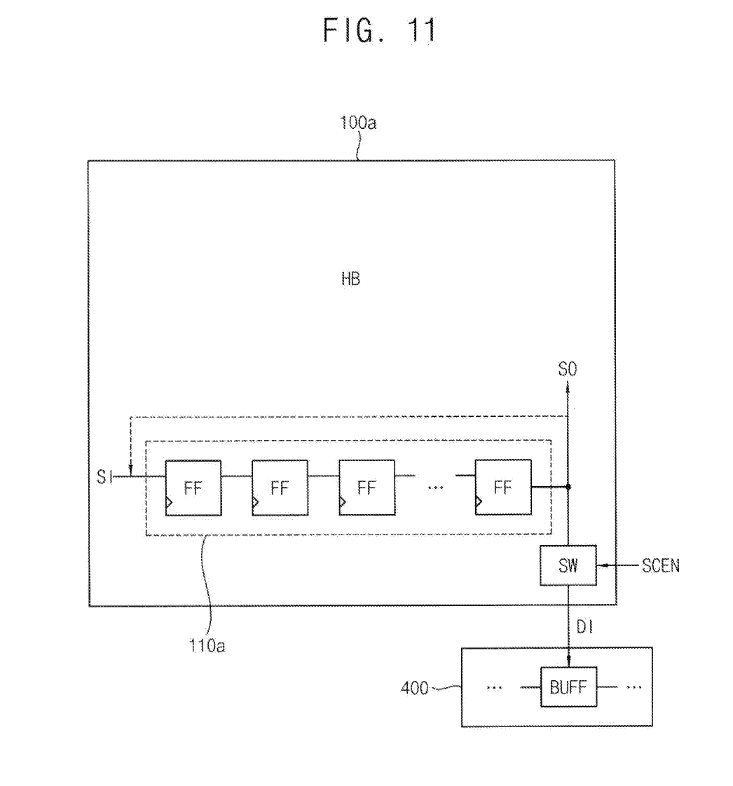

FIG. 11 is a diagram for describing an example embodiment of storing debugging information.

Referring to FIG. 11, a source hardware block HB 100a may include a scan chain 110a in which a plurality of flip-flops FF are cascaded-coupled. As illustrated in FIG. 11, data stored in the scan chain 110a may be provided as the debugging information DINF, e.g., the input data DI to the buffer BUFF in the debugging core 400.

The scan chain 110a may sequentially transfer and shift values provided through a scan input signal SI to provide a scan output signal SO. The scan output signal SO may be provided to an internal circuit (not show) of the source hardware block 100a. As an example embodiment of a non-invasive scheme, the scan output signal SO may be fed back as the scan input signal SI during backup of the debugging information so that the values of the scan chain 110a may be recovered after the scan output is completed. A switch SW may be turned on in response to a scan enable signal SCEN to provide the scan output signal SO as the input data DI to the buffer BUFF. For example, the scan output signal SO may be provided to the internal circuit of the source hardware block 100a and at the same time the scan output signal SO may be provided as the buffer input data DI for the debugging information DINF. As such, the debugging information may be collected invasively or non-invasively.

FIG. 12 is a diagram for describing power domains of a system according to example embodiments.

In general, a system may include a plurality of power domains powered respectively. FIG. 12 illustrates a first power domain PWDM1 and a second power domain

PWDM2 as an example. The first power domain PWDM1 corresponds to an always-powered domain where power is supplied in both of an active mode and a standby mode and the second power domain PWDM2 corresponds to a power-save domain where power is blocked in the standby mode.

As illustrated in FIG. 12, a system counter SYSCNT, a power controller PWCNTR and a deadlock detector DLDET may be disposed in the always-powered domain PWDM1. A plurality of hardware blocks HB1 and HB2 including a processor may be disposed in the power-save domain.

The system counter SYSCNT may generate time information TM and provide the time information TM to internal circuits of the system. The power controller PWCNTR may generate an interrupt ITRR to control supply and block of power. The deadlock detector DLDET may generate a scan enable signal SCEN and a reset signal RST. The deadlock detector DLDET may activate the reset signal RST after storing or backup of the debugging information DINF is completed and the system may be reset or rebooted in response to the reset signal RST.

The deadlock detector DLDET according to example embodiments may be turned on or enabled always by disposing it in the always-power domain PWDM1, and thus storing or backup of the debugging information DINF may be performed in realtime. In some example embodiments, the monitoring units MU1 and MU2 of the deadlock detector 300 in FIG. 3 may be integrated in the hardware blocks HB1 and HB2, respectively, so that the monitoring unit may be disposed in the same power domain as the corresponding hardware block. In this exemplary embodiment, the hardware block in the activated power domain may be electrically connected to the debugging core 400 in the deadlock detector 300 through the debugging bus 11.

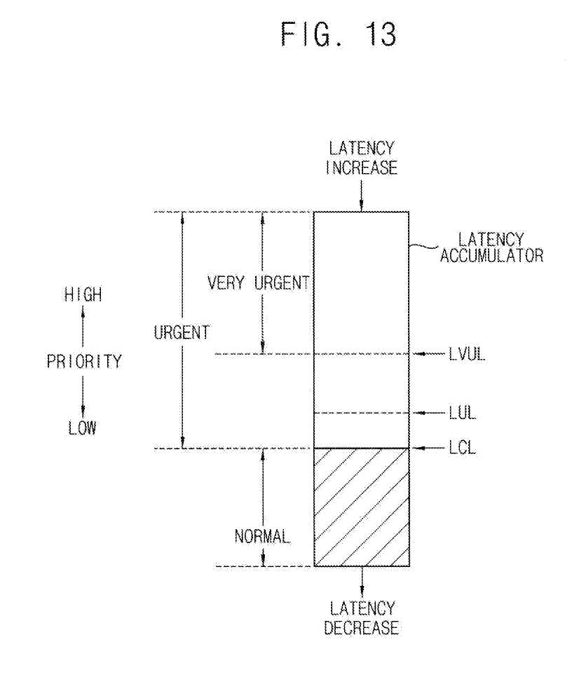

Hereinafter, example embodiments of generating a monitoring signal MON are described with reference to FIGS. 13 through 16. The monitoring signal MON may be generated by various methods other than those of FIGS. 13 through 16.

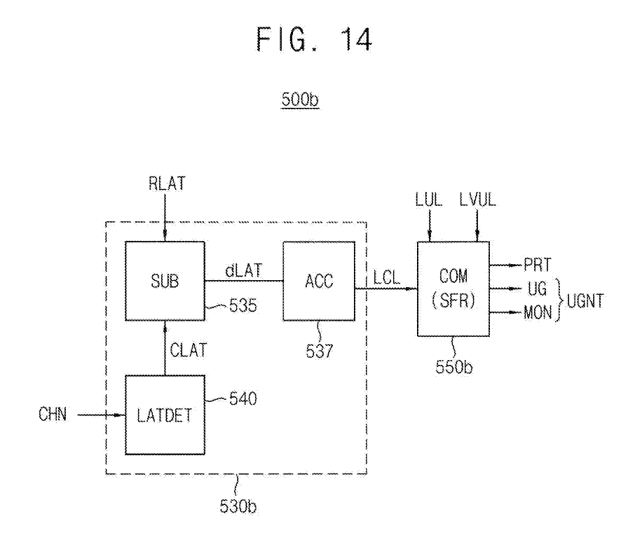

FIG. 13 is a diagram illustrating an accumulator model for realtime monitoring according to example embodiments, and FIG. 14 is a block diagram illustrating an example embodiment of a monitoring unit using the accumulator model of FIG. 13.

Depending on the operational characteristic of the hardware block, for example, the master device (e.g., the processor 100), the service requirement level may be represented as a latency. The latency may be a delay from when the master device issues the request for service to when the requested service has completed. For example, the latency may be represented as a cycle number of a clock signal.

FIG. 13 illustrates a latency state of an accumulator in the master device using oblique lines and the latency state may be represented as a current latency level LCL. The current latency level LCL is increased when the latency of the accumulator is increased and the current latency level LCL is decreased when the latency of the accumulator is decreased. The higher priority may be assigned as the current latency level LCL is increased and the lower priority may be assigned as the current latency level LCL is decreased.

According to overall scenario of a system, reference values such as a latency urgent level LUL and a latency very urgent level LVUL may be determined. An urgent information signal UGNT may be generated based on the reference values LUL and LVUL and the current latency level LCL. The master device may be considered as operating in a normal state when the current latency level LCL is lower than the latency urgent level LUL and then the urgent information signal UGNT may be deactivated.

The urgent information signal UGNT may include a plurality of bits or a plurality of signals to represent whether or how the current latency level LCL corresponds to an urgent situation. For example, the monitoring unit 500b (illustrated in FIG. 14) may generate an urgent flag signal UG that is activated when the current latency level LCL is higher than the latency urgent level LUL and a very urgent flag signal that is activated when the current latency level LCL is higher than the latency very urgent level as will be described below. For example, the very urgent flag signal may correspond to the above-described monitoring signal MON.

Referring to FIG. 14, a monitoring unit 500b may include a latency monitor 530b and a comparator COM 550b.

The latency monitor 530b may generate a current latency level LCL by detecting a latency of the corresponding master device 100 (e.g., in realtime). The latency monitor 530b may include a latency detector (LATDET) 540, a subtractor (SUB) 535 and an accumulator (ACC) 537.

The latency detector 540 may generate a current latency CLAT based on channel signals CHN transmitted between the corresponding master device and the interconnect device 10. The subtractor 535 may calculate a difference between a reference latency RLAT and the current latency CLAT to generate a latency difference value dLAT. The accumulator 537 may accumulate the latency difference value dLAT to generate the current latency level LCL.

The comparator 550b may generate the urgent information signal UGNT and the priority information signal PRT based on at least one of the reference values LUL and LVUL and the current latency level LCL. The comparator 550b may generate the priority information signal PRT such that the priority information signal PRT represents the higher priority as the current latency level LCL increases and the lower priority as the current latency level LCL decreases.

The reference values such as the latency urgent level LUL and the latency very urgent level LVUL may be determined depending on the overall scenario of the system. For example, the reference values LUL and LVUL may be provided to and stored in the comparator 550b during an initializing stage of the system. The comparator 550b may generate the urgent information signal UGNT based on the stored reference values LUL and LVUL.

For example, the comparator 550b may generate the urgent flag signal UG that is activated when the current latency level LCL becomes higher than the latency urgent level LUL, but lower than the latency very urgent level LVUL. The comparator 550b may generate the monitoring signal MON that is activated when the current latency level LCL becomes higher than the latency very urgent level LVUL. The comparator 550b may be implemented as a special function register (SFR) that performs predetermined process sequences in response to stored values and input signals.

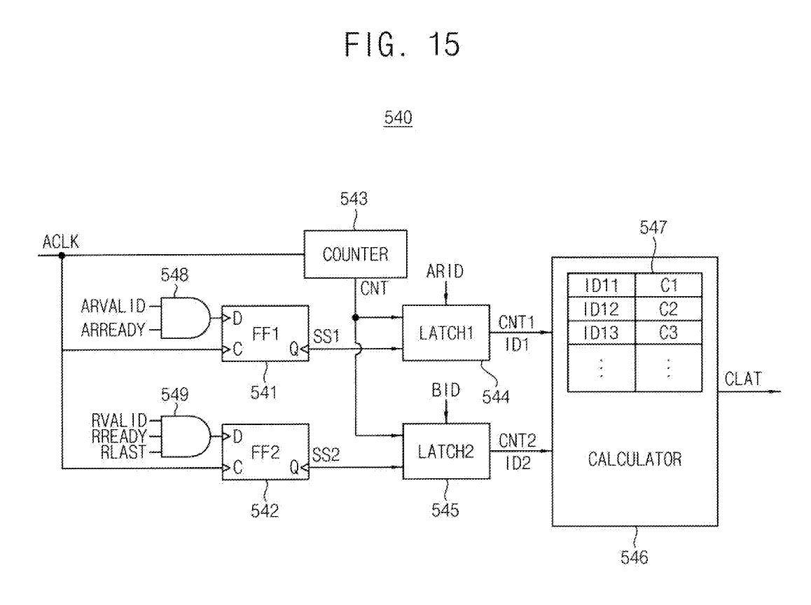

FIG. 15 is a block diagram illustrating an example embodiment of a latency detector included in the monitoring unit of FIG. 14.

Referring to FIG. 15, a latency detector 540 include a first flip-flop (FF1) 541, a second flip-flop (FF2) 542, a counter 543, a first latch (LATCH1) 544, a second latch (LATCH2) 545, a calculator 546, a first logic gate 548 and a second logic gate 549.

For example, the first logic gate 548 may be implemented as an AND gate that performs an AND operation on a request valid signal ARVALID and a request ready signal ARREADY to output an operation result. The output of the first logic gate 548 is input to a data terminal D of the first flip-flop 541 and a global clock signal ACLK is input to a clock terminal C of the first flip-flop 541. The first flip-flop 541 samples the output of the first logic gate 548 in response to the global clock signal ACLK to output a first sampling signal SS1 though an output terminal Q. For example, the first flip-flop 541 may sample the output of the first logic gate 548 in response to a rising edge of the global clock signal ACLK.

For example, the second logic gate 549 may be implemented as an AND gate that performs an AND operation on a service valid signal RVALID, a service ready signal RREADY and a service done signal RLAST to output an operation result. The output of the second logic gate 549 is input to a data terminal D of the second flip-flop 542 and the global clock signal ACLK is input to a clock terminal C of the second flip-flop 542. The second flip-flop 542 samples the output of the second logic gate 549 in response to the global clock signal ACLK to output a second sampling signal SS2 though an output terminal Q. For example, the second flip-flop 542 may sample the output of the second logic gate 549 in response to a rising edge of the global clock signal ACLK.

The counter 543 counts a cycle number of the global clock signal ACLK to provide a count signal CNT.

The first latch 544 latches the count signal CNT in response to first sampling signal SS1 to provide a start count signal CNT1. For example, the first latch 544 may latch the count signal CNT in response to a rising edge of the first sampling signal SS1. The first latch 544 may receive a first identification signal ARID associated with the request signals ARVALID and ARREADY to provide a first identification code ID1.

The second latch 545 latches the count signal CNT in response to the second sampling signal SS2 to provide an end count signal CNT2. For example, the second latch 545 may latch the count signal CNT in response to a rising edge of the second sampling signal SS2. The second latch 545 may receive a second identification signal BID associated with the service signals RVALID, RREADY and RLAST to provide a second identification code ID2.

The calculator 546 generates a current latency CLAT based on the start count signal CNT1 and the end count signal CNT2. When the system adopts a protocol supporting multiple outstanding transactions between the master devices, the interconnect device and the slave devices, the identification signals ARID and BID may be used to determine whether the request signals ARVALID and ARREADY are associated with the same transaction as the service signals RVALID, RREADY and RLAST.

Whenever the start count signal CNT1 and the first identification code ID1 are input, the calculator 546 may upgrade a mapping table 547 to store values ID11, ID12 and ID13 of the first identification code ID1 and corresponding count values C1, C2 and C3 of the start count signal CNT1. When the end count signal CNT2 and the second identification code ID2 are input, the calculator 546 extracts one of the count values C1, C2 and C3 from the mapping table 547 by comparing the value of the second identification signal ID2 and the previously stored values ID11, ID12 and ID13 of the first identification signal ID1.

The calculator 546 may generate the current latency CLAT by calculating the difference between the extracted value representing the service request timing point and the value representing the issue done timing point.

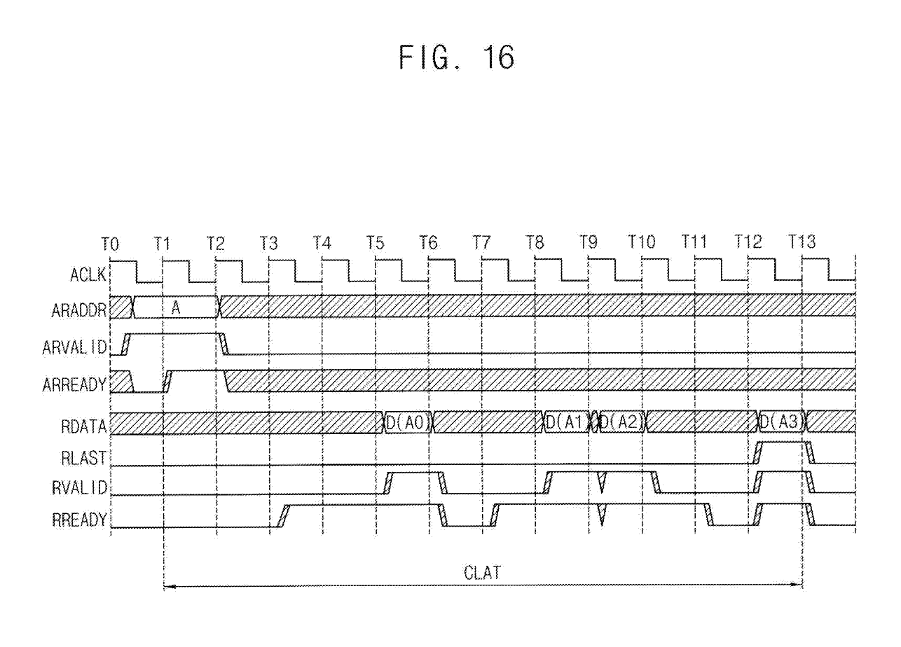

FIG. 16 is a timing diagram illustrating an example transaction performed by a system and a current latency detected by the latency detector of FIG. 15.

FIG. 16 illustrates an example of a read transaction according to an advanced extensible interface (AXI) protocol. The AXI protocol adopts a handshake scheme using valid signals and ready signals.

According to the handshake scheme, if a first one of a master interface and a slave interface transfers a signal to a second one of the master interface and the slave interface, the first one activates a valid signal, and then the second one activates a ready signal corresponding to the valid signal when the second one is ready to receive the signal. Sampling of signals is performed in response to rising edges of a global clock signal ACLK at both of the master interface and the slave interface. For example, a valid signal transfer is fulfilled when both of the valid signal and the ready signal are activated at the same rising edge of the global clock signal ACLK.

As illustrated in FIG. 16, the master device corresponding to the master interface activates a request valid signal ARVALID when the master device transfers a signal and the interconnect device corresponding to the slave interface activates a request ready signal ARREADY when the interconnect device is ready to receive the signal from the master device. In the same way, the interconnect device activates a service valid signal RVALID when the interconnect device transfers a signal and the master device activates a service ready signal RREADY when the master device is ready to receive the signal from the interconnect device.

The rising edges of the global clock signal ACLK are represented as timing points T0 through T13 in FIG. 16. The master interface corresponding to the master interface transfers a read request signal ARADDR to the interconnect device corresponding to the slave interface by activating the request valid signal ARVALID corresponding to a service request signal. The read request signal ARADDR is transferred successfully at the timing point T2 when both of the request valid signal ARVALID and the request ready signal ARREADY are activated. The master device 100 may determine the timing point T1 as a service request timing point based on the request valid signal ARVALID regardless of the request ready signal, e.g., regardless of the success of the valid signal transfer.

As a response to the read request, data D(A0), D(A1), D(A2) and D(A3) of a burst type are transferred from the interconnect device to the master device. The data D(A0), D(A1), D(A2) and D(A3) are transferred successfully at timing points T6, T9, T10 and T13, respectively, when both of the service valid signal RVALID and the service ready signal RREADY are activated. The interconnect device activates a service done signal RLAST with transferring the last data D(A3), and the timing point T13 is determined as a service done timing point.

As such, the latency detector 540 of FIG. 15 may detect the current latency CLAT based on the request signals ARVALID and ARREADY and the service signals RVALID, RREADY and RLAST among the channel signals CHN between the master device and the interconnect device.

In some example embodiments, the monitoring signal MON may be activated when the current latency level LCL becomes higher than the latency very urgent level LVUL as described with reference to FIGS. 13 through 16.

In other example embodiments, the monitoring signal MON may be generated based on the request valid signal ARVALID and the request ready signal ARREADY. As described above, the master device corresponding to the master interface activates the request valid signal ARVALID when the master device transfers a signal and the interconnect device corresponding to the slave interface activates the request ready signal ARREADY when the interconnect device is ready to receive the signal from the master device. If the request ready signal ARREADY is not activated for a reference time after the request valid signal ARVALID is activated, the monitoring unit according to example embodiments may determine the abnormal state of at least one of the slave device and the interconnect device to activate the monitoring signal MON.

In still other example embodiments, the monitoring signal MON may be generated based on the service valid signal RVALID and the service ready signal RREADY. As described above, the interconnect device activates the service valid signal RVALID when the interconnect device transfers a signal and the master device activates the service ready signal RREADY when the master device is ready to receive the signal from the interconnect device. If the service ready signal RREADY is not activated for a reference time after the service valid signal RVALID is activated, the monitoring unit according to example embodiments may determine the abnormal state of the master device to activate the monitoring signal MON.

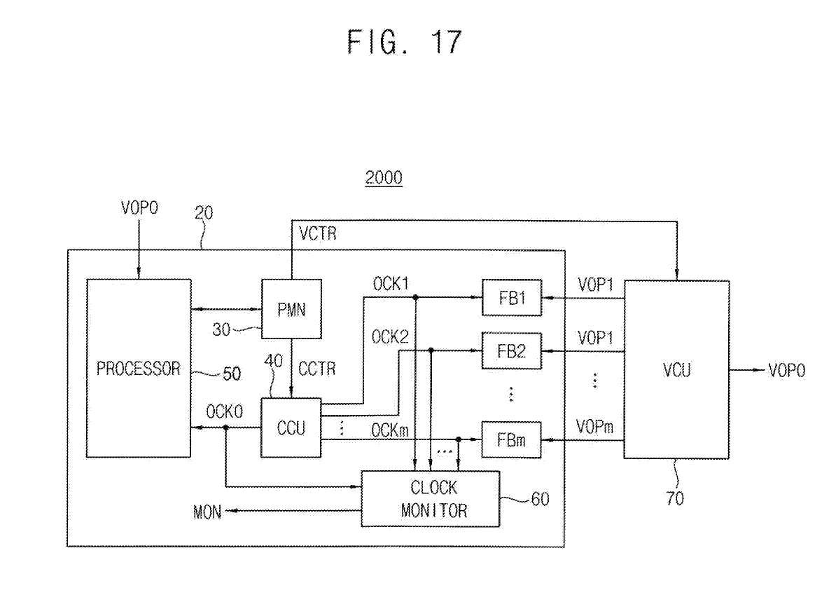

FIG. 17 is a block diagram illustrating a system according to example embodiments.

Referring to FIG. 17, a system 2000 may include an integrated circuit 20 and a voltage control unit (VCU) 70 (e.g., voltage controller or power controller). The integrated circuit 20 may include at least one processor 50, a power management unit (PMN) 30 (e.g., power manager), a clock control unit (CCU) 40 (e.g., clock controller), one or more function blocks FB1˜FBm and a clock monitor 60.

The integrated circuit 20 may be a system on chip (SOC) in which various hardware blocks are integrated as one chip. For example, each hardware block may comprise a processor to perform various functions. Some hardware blocks may comprise embedded memory or input/output buffers of the SOC. hardware blocks may be connected by one or more system busses of the SOC. Examples of the hardware blocks include a CODEC, display controller, image signal processor, and the functional blocks described herein. The integrated circuit 20 may be powered by the voltage control unit 70. The voltage control unit 70 may include at least one voltage regulator. The voltage control unit 70 may be referred to as a power supply or a power management integrated circuit (PMIC). According to example embodiments, the voltage control unit 70 may be implemented as another chip distinct from the chip of the integrated circuit 20, or at least a portion of the voltage control unit 70 may be included in the integrated circuit 20.

Even though one processor 50 is illustrated in FIG. 17 for convenience of illustration, the integrated circuit 20 may further include one or more processors or processing units. The processor 50 may be a central processing unit (CPU) for performing main functions of the integrated circuit 20. The processor 50 may be configured to perform program instructions, such as those of an operating system (OS).

The power management unit 30 may monitor the operating status or the operating condition of the integrated circuit 20 to determine an operating power level corresponding to the present operating condition. The power level may be changed by changing at least one of the operating voltage and the operating frequency.

The power management unit 30 may monitor the operating status or the operating condition such as the workload, the operating temperature, etc., of the integrated circuit 20 to determine the operating power level corresponding to the present operating condition. The power management unit 30 may generate a voltage control signal VCTR and a clock control signal CCTR, and the voltage control unit 70 and the clock control unit 40 may provide the operating voltage and the operating frequency corresponding to the determined operating power level in response to the generated voltage control signal VCTR and the generated clock control signal CCTR, respectively. The operating power level may be altered by changing at least one of the operating voltage and the operating frequency. In some example embodiments, the power management unit 30 may control the power level of a portion of the integrated circuit 20 independently of the power level of another portion of the integrated circuit 20. For example, when the processor 50 and the function blocks FB1˜FBm are included in different power domains, the operating voltages VOP0˜VOPm provided to the processor 50 and the function blocks FB1˜FBm may be controlled independently. In addition, when the processor 50 and the function blocks FB1˜FBm are included in different clock domains, the operating clock signals OCK0˜OCKm provided to the processor 50 and the function blocks FB1˜FBm may be controlled independently.

The function blocks FB1˜FBm may perform predetermined functions and each of the function blocks may be an intellectual property core or IP core (which may be the same or different from other IP cores) of the integrated circuit 20. For example, the function blocks FB1˜FBm may include a memory controller, a central processing unit (CPU), a display controller, a file system block, a graphic processing unit (GPU), an image signal processor (ISP), a multi-format codec block (MFC), etc. The processor 50 and the power management unit 30 may be the independent function blocks, respectively.

The clock control unit 40 may generate the operating clock signals OCK0˜OCKm that are provided to the processor 50 and the function blocks FB1˜FBm, respectively. The clock control unit 40 may include at least one of a phase-locked loop (PLL), a delay-locked loop (DLL), a clock multiplier, and a clock diver.

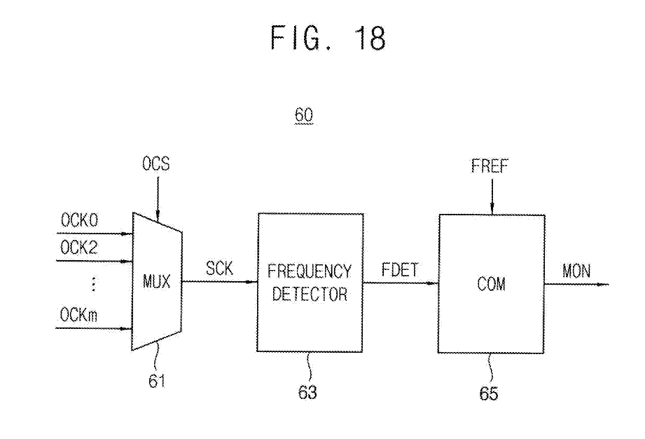

The clock monitor 60 monitors the frequencies of the operating clock signals OCK0˜OCKm to generate a monitoring signal MON. The clock monitor 60 is described with reference to FIG. 18.

FIG. 18 is a block diagram illustrating a clock monitor included in the system of FIG. 17.

Referring to FIG. 18, a clock monitor 60 may include a selector MUX 61, a frequency detector 63 and a comparator 65.

The selector 61 may select one of a plurality of operating clock signals OCK0˜OCKm, which are provided to a processor 50 and a plurality of function blocks FB1˜FBm in FIG. 1, respectively, to provide a selected clock signal SCK. The frequency detector 63 may detect a frequency of the selected clock signal SCK to provide a detection frequency FDET. The comparator 65 may compare the detection frequency FDET and a reference value FREF to generate a monitoring signal indicating abnormality of the operating clock signal corresponding to the selected clock signal SCK.

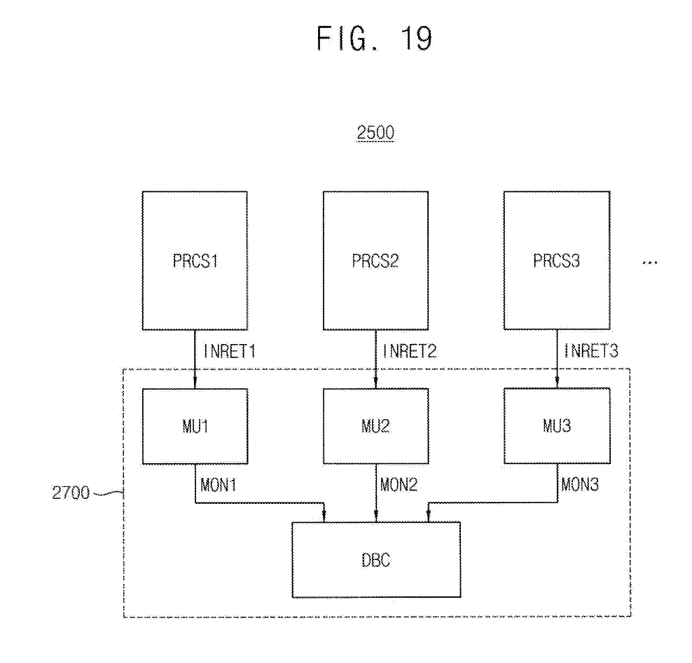

FIG. 19 is a block diagram illustrating a system according to example embodiments.

Referring to FIG. 19, a system 2500 may include a plurality of processors PRCS1, PRCS2 and PRCS3 and a deadlock detector 2700. FIG. 19 illustrates the three processors PRCS1, PRCS2 and PRCS3 for convenience of illustration but the number of the processors included in the system 2500 may be determined variously. At least two processors in the system 2500 may be independent cores and thus the system 2500 may be a multi-core system on chip.

The deadlock detector 2700 may include a plurality of monitoring units MU1, MU2 and MU3 and a debugging core DBC. The monitoring units MU1, MU2 and MU3 may monitor the operations of the processors PRCS1, PRCS2 and PRCS3, e.g., the target hardware blocks in realtime to generate monitoring signals MON1, MON2 and MON3 each indicating an abnormal state of the corresponding target hardware block. The debugging core DBC may store the debugging information in a storage device based on the monitoring signals MON1, MON2 and MON3.

In some example embodiments, as described with reference to FIGS. 8 and 9, the processors PRCS1, PRCS2 and PRCS3 may provide instruction-retired signals INRET1, INRET2 and INRET3, respectively. Each instruction-retired signal may be activated in a pulse form whenever the above-instruction event of the corresponding processor occurs. Each of the monitoring units MU1, MU2 and MU2 may determine an abnormal state of the corresponding processor and activate each of the monitoring signals MON1, MON2 and MON3 if each of the instruction-retired signals INRET1, INRET2 and INRET3 is not activated for relatively a long time. The debugging core DBC may perform storing or backup of the debugging information as described above in response to the monitoring signals MON1, MON2 and MON3.

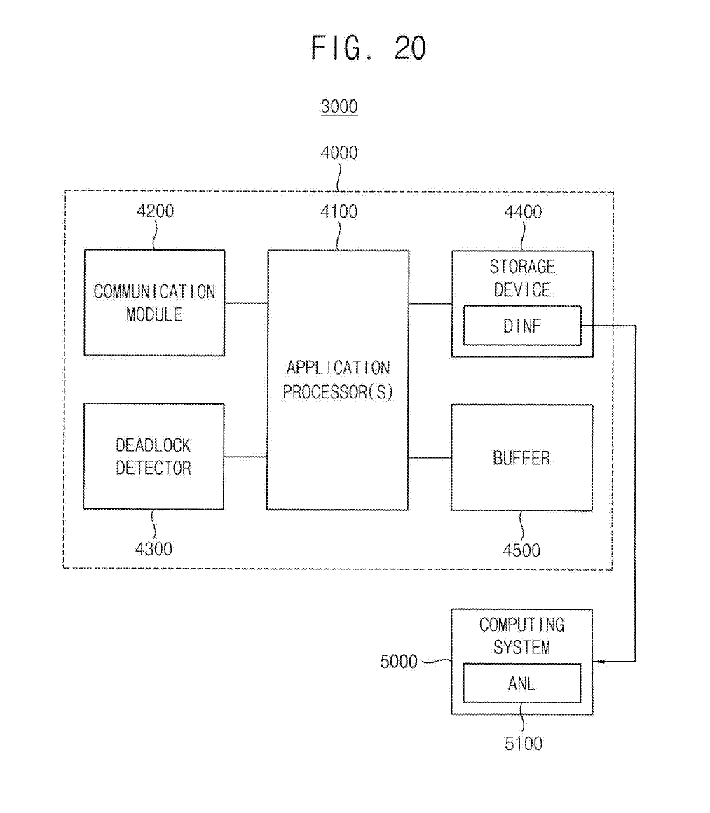

FIG. 20 is a block diagram illustrating a diagnosis system according to example embodiments.

Referring to FIG. 20, a diagnosis system 3000 may include a mobile device 4000 and a computing system 5000.

The mobile device 4000 may include an application processor 4100, a communication module 4200, a deadlock detector 4300, a storage device 4400, and a mobile buffer 4500.

The application processor 4100 controls operations of the mobile device 4000. The communication module 4200 can perform wireless or wired communications with an external device. The deadlock detector 4300 may monitor operations of the mobile device 4000 in realtime to store debugging information in the storage device 4400 as described above.

The storage device 4400 can store user data. The storage device 4400 may be an embedded multimedia card (eMMC), a solid state drive (SSD), a universal flash storage (UFS) device, etc. The storage device 4400 may be included in the mobile device 4000 as illustrated in FIG. 20 or the storage device 4400 may be disposed out of the mobile device 4400. For example, an external debugger device including the storage device may be connected to the mobile device to receive the debugging information. The mobile buffer 4500 may be a double data rate (DDR) synchronous dynamic random access memory (SDRAM), a low power DDR (LPDDR) SDRAM, a graphics DDR (GDDR) SDRAM, a Rambus DRAM (RDRAM), etc. In some example embodiments, the deadlock detector 4300 may store the debugging information in the mobile buffer 4500. In this case, when the mobile device is powered off, the debugging information in the mobile buffer 4500 may be pushed to the storage device 4400 according to the general power-off process before the mobile device 4000 is off completely.

The computing system may include an analysis tool ANL 5100, and perform debugging operation with respect to the mobile device 4000 based on the debugging information, using the analysis tool 5100.

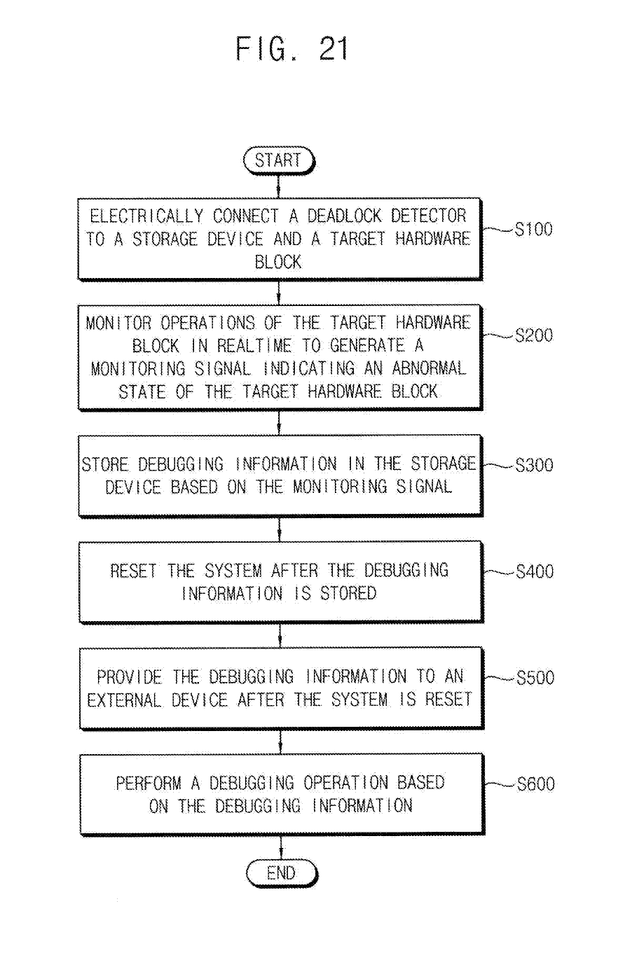

FIG. 21 is a flow chart illustrating a method of diagnosing a system according to example embodiments.

Referring to FIGS. 20 and 21, the deadlock detector 4300 may be electrically connected to the storage device 4400 and a target hardware block among the plurality of hardware blocks (S100). For example, the target hardware block may be the application processor 4100. Operations of the target hardware block may be monitored in realtime to generate a monitoring signal indicating an abnormal state of the target hardware block, using the deadlock detector 4300 (S200). Debugging information may be stored in the storage device 4400 based on the monitoring signal, using the deadlock detector (S300). The mobile device 4000 may be reset using the reset signal RST illustrated in FIG. 10 after the debugging information is stored in the storage device 4400 (S400). The debugging information may be provided to an external device, for example, the computing system 5000 after the mobile device 4000 is reset (S500). The computing system 5000 may perform a debugging operation based on the debugging information (S600). In some example embodiments, the mobile device 4000 may not be reset and the debugging information may be retained in the storage device 4400 until the mobile device 4000 is rebooted.

In some example embodiments, the debugging information may include data stored in a program counter and a general purpose register included in the processor 4100.

In other example embodiments, the debugging information may include data stored in a scan chain that is included in a source hardware block among a plurality of hardware blocks.

In other example embodiments, the mobile device 4000 may further include a special function register that stores data representing states of the hardware blocks in the mobile device 4000 and the debugging information may include data stored in the special function register.

Such debugging information are non-limiting examples and other various data may be collected as the debugging information.

A conventional method based on a watchdog timer can hardly analyze the root cause of the deadlock because the expired time of the watchdog timer is about ten seconds. In contrast, the method according to example embodiments may monitor the hardware behavior in realtime while the OS works. For example, the hardware behavior may be monitored periodically in synchronization with a timer interrupt and the debugging information may be collected if abnormality is detected. In case of the OS, performance monitoring with a short cyclic period may not be possible with conventional methods, but the deadlock detector according to example embodiments may collect the debugging information with a cyclic period shorter than one millisecond.

If a system on chip (SOC) falls in an abnormal state during a normal operation, it takes relatively a long time to analyze a cause thereof. A conventional scheme depending on software cannot catch all status of logics in the SOC at a time point when the SOC falls in deadlock. In contrast, the deadlock detector and the method of deadlock detection according to example embodiments may extract and store information of hardware logic in order to find an exact cause of the problem in the hardware logic.

In some conventional methods, software log may be used for post-analysis. Using these methods, however, an exact cause of deadlock cannot be analyzed exactly in case of hardware problems. In contrast, the deadlock detector and the method of deadlock detection according to example embodiments may solve hardware problems in addition to software problem.

In other conventional methods, break point may be inserted in software codes and an external tester may extract and analyze the associated information if an event associated with the break point occurs. In contrast, the deadlock detector and the method of deadlock detection according to example embodiments may secure the debugging information at a time of deadlock regardless of the predetermined break point.

As such, the deadlock detector, the system including the deadlock detector and the associated method according to example embodiments may support efficient debugging and enhance probability of success in debugging by monitoring the abnormal state of the system in realtime to secure the debugging information.

The present exemplary embodiments may be applied to any devices and systems. For example, the present exemplary embodiments may be applied to systems such as a mobile phone, a smart phone, a personal digital assistant (PDA), a portable multimedia player (PMP), a digital camera, a camcorder, personal computer (PC), a server computer, a workstation, a laptop computer, a digital TV, a set-top box, a portable game console, a navigation system, etc.

The foregoing is illustrative of example embodiments and is not to be construed as limiting thereof Although a few example embodiments have been described, those skilled in the art will readily appreciate that many modifications are possible in the example embodiments without materially departing from the present inventive concept.

1. A system comprising:
a plurality of hardware blocks, at least one hardware block among the plurality of hardware blocks including a processor configured to execute instructions and at least one hardware block among the plurality of hardware blocks including a storage device configured to store data;
a deadlock detector configured to monitor operations of a target hardware block among the plurality of hardware blocks in realtime to generate a monitoring signal indicating an abnormal state of the target hardware block and to store debugging information in the storage device in response to generation of the monitoring signal; and
an interconnect device electrically connecting the deadlock detector and the plurality of hardware blocks, the interconnect device comprising,
a system bus electrically connecting the plurality of hardware blocks; and
a debugging bus electrically connecting the deadlock detector to the target hardware block and the storage device.

2. The system of claim 1, wherein the target hardware block corresponds to the hardware block that includes the processor, and the processor includes a performance monitor unit that includes a plurality of counters each configured to count corresponding different events of the processor.

3. The system of claim 2, wherein the performance monitor unit provides an event count value corresponding to a counted number of monitored events, and
wherein the deadlock detector monitors the operations of the processor based on the event count value.

4. The system of claim 3, further comprising:
a system counter configured to provide time information,
wherein the performance monitor unit provides the event count value periodically based on the time information from the system counter such that the deadlock detector monitors the operations of the processor periodically.

5. The system of claim 4, wherein a cyclic period of monitoring the operations of the processor is shorter than one millisecond.

6. The system of claim 2, wherein the performance monitor unit provides an instruction-retired signal that is activated in a pulse form whenever each instruction of the processor is executed and completed, and
wherein the deadlock detector monitors the operations of the processor based on the instruction-retired signal.

7. The system of claim 1, wherein the deadlock detector controls the system such that the system is reset after the debugging information is stored in the storage device.

8. The system of claim 1, wherein the deadlock detector is disposed in a manner such that power is supplied to the deadlock detector during both of an active mode and a standby mode of the system.

9. The system of claim 1, wherein the deadlock detector is disabled when the system enters a standby mode such that power to the processor is blocked, and the deadlock detector is enabled when the system enters an active mode from the standby mode.

10. The system of claim 1, wherein the deadlock detector includes:
a monitoring unit configured to monitor the operations of the target hardware block in realtime to generate the monitoring signal indicating the abnormal state of the target hardware block; and
a debugging core configured to store the debugging information in the storage device based on the monitoring signal.

11. The system of claim 10, wherein the monitoring unit includes:
a comparator configured to receive an event count value corresponding to a counted number of monitored events and configured to compare the event count value with a reference value to generate the monitoring signal.

12. The system of claim 10, wherein the monitoring unit includes:
a counter configured to receive an instruction-retired signal that is activated in a pulse form whenever each instruction of the processor is executed and completed, configured to generate a count signal by performing a counting operation and configured to be reset in response to pulses of the instruction-retired signal; and
a comparator configured to compare a value of the count signal with a reference value to generate the monitoring signal.

13. The system of claim 10, wherein the monitoring unit generates the monitoring signal based on a valid signal and a ready signal of the target hardware block.

14. The system of claim 10, wherein the debugging core includes:
a scan controller configured to generate a scan enable signal based on the monitoring signal to transfer the scan enable signal to a source hardware block among the plurality of the hardware blocks, the source hardware block storing the debugging information, the scan enable signal indicating a start timing of storing the debugging information;
a register configured to store control values for operations of the debugging core;
a buffer configured to temporarily store the debugging information provided from the source hardware block; and
an output unit configured to transfer the debugging information stored in the buffer to the storage device.

15. The system of claim 14, wherein the scan controller generates a scan clock signal to provide the scan clock signal to the source hardware block, the buffer and the storage device.

16. The system of claim 1, wherein the debugging information includes data stored in a program counter and a general purpose register included in the processor, data stored in a scan chain that is included in a source hardware block among the plurality of hardware blocks, or data stored in a special function register.

17. The system of claim 1, wherein the debugging information includes data stored in a scan chain that is included in a source hardware block among the plurality of hardware blocks, and an output signal of the scan chain is fed back as an input signal of the scan chain such that the data stored in the scan chain is non-invasively provided as the debugging information.

18. A system comprising:
a plurality of hardware blocks; and
a deadlock detector for collecting debugging information of the system, the deadlock detector comprising:
a monitoring unit configured to monitor operations of a target hardware block among the plurality of hardware blocks in realtime to generate a monitoring signal indicating an abnormal state of the target hardware block;
a debugging core configured to store the debugging information in a storage device corresponding to one of the plurality of the hardware blocks based on the monitoring signal; and
a debugging bus configured to electrically connect the deadlock detector to the target hardware block and the storage device.

19. The system of claim 18, wherein the target hardware block corresponds to a processor and the monitoring unit generates the monitoring signal based on an instruction-retired signal that is activated in a pulse form whenever each instruction of the processor is executed and completed.

20. A method of detecting deadlock in a system comprising a plurality of hardware blocks, the method comprising:
electrically connecting a deadlock detector to a target hardware block among the plurality of hardware blocks that includes a processor configured to execute instructions and to at least one hardware block among the plurality of hardware blocks that includes a storage device configured to store data;
monitoring operations of the target hardware block in realtime to generate a monitoring signal indicating an abnormal state of the target hardware block, using the deadlock detector; and
storing debugging information in the storage device based on the monitoring signal, using the deadlock detector.

21. (canceled)

22. (canceled)
